(19) United States
(12) Patent Application Publication
(10) Pub. No.: US 2024/0047728 A1
(43) Pub. Date: Feb. 8, 2024

(54) ELECTRODE-LESS, MEMBRANE-LESS HIGH VOLTAGE BATTERIES

(71) Applicant: URBAN ELECTRIC POWER INC., Pearl River, NY (US)

(72) Inventors: Gautam G. YADAV, Pearl River, NY (US); Meir WEINER, Pearl River, NY (US); Aditya UPRETI, Pearl River, NY (US); Sanjoy BANERJEE, Pearl River, NY (US); Jinchao HUANG, Pearl River, NY (US)

(21) Appl. No.: 18/259,021

(22) PCT Filed: Dec. 22, 2021
(86) PCT No.: PCT/US2021/064951

§ 371 Date: Jun. 22, 2023

Related U.S. Application Data
(60) Provisional application No. 63/129,896, filed on Dec. 23, 2020.

(51) Int. Cl. H01M 10/02; H01M 10/28; H01M 10/0563; H01M 10/0562

(52) U.S. Cl. CPC H01M 10/02; H01M 10/28; H01M 10/0563; H01M 10/0562

(57) ABSTRACT

An electrode-less and membrane-less battery includes: a cathode current collector; an anode current collector; a liquid or solid polymerized catholyte including dissolved active ions in contact with the cathode; a liquid or solid polymerized anolyte including dissolved active ions in contact with the anode; and a ceramic or solid polymerized buffer including active and working ions disposed between the catholyte and the anolyte.

### CROSS-REFERENCE TO RELATED APPLICATIONS

This application claims the benefit of U.S. Provisional Application No. 63/129,896, filed on Dec. 23, 2020, and entitled “High Voltage Membrane-Less Electrode-Less Batteries”, which is incorporated herein by reference in its entirety for all purposes.

### STATEMENT REGARDING GOVERNMENTALLY SPONSORED RESEARCH OR DEVELOPMENT

Not applicable.

### BACKGROUND

The current century can be considered as the “renewables century” as renewable sources of energy are increasingly integrated into the grid, electric vehicles begin to replace gasoline fueled cars, the personal electronics market increases, and green manufacturing processes are further established for reducing the carbon footprint. Generally, energy storage is vital in transitioning into the renewables' century. Currently, the energy storage landscape is typically dominated by lithium-ion and lead acid batteries that are not produced through green manufacturing processes, contain toxic elements and usually are mined unethically and are highly flammable. These shortcomings negate any development made by transitioning from carbon emitting sources to renewable sources. The transition to a truly renewables century may require the development of energy storage devices manufactured through green processes with safe and non-toxic elements.

Generally, energy storage devices are increasingly more important for future applications. Personal electronics, electric vehicles, wireless devices, etc. typically require batteries with high power and energy densities. High voltage and capacity may be important to obtain energy densities and lithium-ion may provide these characteristics for the past two decades. However, lithium-ion batteries are generally flammable, toxic, and expensive and usually contain elements like cobalt that may be mined unethically.

Moreover, the manufacturing component of energy storage devices, especially lithium-ion and lead acid batteries, is energy intensive. Grinding, mixing, pasting or casting, and heating the powders onto a current collector generate and utilize large amounts of energy and heat. The solvents used in mixing the powders and casting them onto a current collector are toxic and require recapture columns as an additional step which not only increase the size and complexity of the manufacturing plant but also adds another energy consuming step that strains the plant economics and engineering steps.

### SUMMARY

These and other features will be more clearly understood from the following detailed description taken in conjunction with the accompanying claims.

In some embodiments, an electrode-less and membrane-less battery includes: a cathode current collector; an anode current collector; a liquid or solid polymerized catholyte including dissolved active ions in contact with the cathode; a liquid or solid polymerized anolyte including dissolved active ions in contact with the anode; and a ceramic or solid polymerized buffer including active and working ions disposed between the catholyte and the anolyte.

In some embodiments, a method of forming an electrode-less and membrane-less battery, includes: forming a liquid or solid polymerized catholyte including dissolved active ions; forming a liquid or solid polymerized anolyte including dissolved active ions; forming a ceramic or solid polymerized buffer including active and working ions; layering the buffer between the catholyte and the anolyte; disposing a cathode current collector in contact with the catholyte; and disposing an anode current collector in contact with the anolyte.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic cross sectional view of a battery assembled in a discharged state according to some embodiments.

FIG. 2 is a schematic cross sectional view of a battery assembled in a charged state according to some embodiments.

FIG. 3 is a schematic diagram of a battery assembled in a discharged state according to some embodiments.

FIG. 4 is a schematic diagram of a battery assembled in a discharged state and then charged to form the battery.

FIG. 5 is a schematic of making a battery according to some embodiments.

FIG. 6 illustrates a voltage versus time for a test battery as described in Example 2.

FIG. 7 illustrates a voltage versus time for a test battery as described in Example 2.

FIG. 8 illustrates a voltage versus time for a test battery as described in Example 3.

FIG. 9 illustrates a voltage versus time for a test battery as described in Example 3.

FIG. 10 illustrates a real capacity versus cycle number for a test battery as described in Example 3.

### DETAILED DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused. As used herein, a catholyte refers to an electrolyte solution in contact with the cathode without being in direct contact with the anode, and an “anolyte” refers to an electrolyte solution in contact with the anode without being in direct contact with the cathode.

High voltage batteries may have elements such as zinc, manganese, aluminum, magnesium, copper, iron, lithium etc. that are safe, cheap and can be mined ethically. Electrolytes used may be non-flammable. The battery disclosed herein is “electrode-less” meaning that the assembled battery has no or substantially no active materials pasted onto the cathode and/or anode current collector. Moreover, the battery can be membrane-less as well, and include a liquid or solid polymerized catholyte including dissolved active ions in contact with the cathode; a liquid or solid polymerized anolyte including dissolved active ions in contact with the anode; and a ceramic or solid polymerized buffer including active and working ions disposed between the catholyte and the anolyte. The creation of this new membrane-less electrode-less high voltage battery is the first approach reported for highly energy dense batteries with generally ultra-low-cost with respect to materials. Thus, a paradigm shift in the manufacturing of energy-dense (high voltage and high capacity) batteries of the future can be obtained.

The active materials are usually plated onto the respective current collectors upon charging of the battery after the cell is constructed. The plated material typically delivers the capacity and energy of the battery at high voltages between 1 and 5 volt (V) on subsequent discharges. Although not wanting to be bound by theory, when the cathode current collector is immersed in electrolyte (e.g., the catholyte) with pH ranging from acidic to alkaline and/or of one or more specific types (e.g., aqueous, organic, ionic liquid) and the anode is immersed in electrolyte (e.g., the anolyte) with pH ranging from acidic to alkaline and/or of a specific type (e.g., aqueous, organic, ionic liquid), where the catholyte and the anolyte can have different compositions, using a dual electrolyte approach may obtain high voltage in the battery. This battery may also be “membrane-less”, where the differing pH or type is separated or regulated by using a buffer interlayer. The buffer may act to regulate pH in this system. This battery can be completely polymerized or one or more portions (e.g., the catholyte, the anolyte, and/or the buffer layer) can remain liquid. The creation of this new membrane-less electrode-less high voltage battery advantageously can be constructed in a low cost manner. This can allow for a paradigm shift in the manufacturing of energy-dense (high voltage and high capacity) batteries of the future.

Thus, an energy storage device can be “electrode-less” and “membrane-less”, where the high energy consumption steps of grinding, mixing, pasting or casting, and heating the powders onto a current collector are eliminated to create a green manufacturing process. The complexity of assembling electrodes with separators in traditional battery manufacturing is also eliminated as the battery disclosed is “membrane-less”. This electrode-less and membrane-less battery is also solid-state, thus significantly simplifying the manufacturing process and increasing the safety of the device and application.

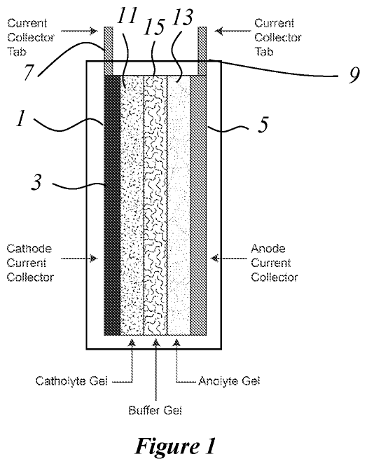

Referring to FIG. 1, a battery 1 can have a cathode or cathode current collector 3, an anode or anode current collector 5, a current collector tab 7 for the cathode 3, a current collector tab 9 for the anode 5, a catholyte or catholyte gel 11, an anolyte or anolyte gel 13, and a buffer or buffer gel 15, each of which can be disposed in a housing. The current collector tab 7 may be coupled to the cathode current collector 3 and the current collector tab 9 may be coupled to the anode current collector 5. It is noted that the scale of the components in FIG. 1 may not be exact as the features are illustrated. Furthermore, there are no or substantially no active electrode materials, such as powder, on the current collectors 3 and 5 when the cell is constructed and/or fully discharged. In some embodiments, the battery is initially in a discharged state, with the catholyte gel 11 and the anolyte gel 13 including the active ions. The liquid or solid polymerized catholyte gel 11 can include dissolved active ions in contact with the cathode current collector 3. The liquid or solid polymerized anolyte gel 13 can include dissolved active ions in contact with the anode current collector 5. Moreover, the ceramic or solid polymerized buffer gel 15 can include active and working ions disposed between the catholyte gel 11 and the anolyte gel 13. As such, the battery 1 is depicted in a discharged state.

In some embodiments, the battery 1 includes current collectors 3 and 5 and three distinct layers 11, 13, and 15, which are typically in their solid-state. Solid-state can mean a gel, a ceramic or mixture of both. When a gel is used, the electrolyte can act as a solid in the sense that the gel may not flow in response to pressure. The electrode-less aspect of the battery 1 utilizes no or substantially no active material pasted onto the current collector 3 or 5. Rather, the active materials are dissolved or mixed into the solid-state layers (catholyte and anolyte) that are near to the respective current collectors 3 and 5. In some aspects, the membrane-less aspect of this battery 1 utilizes no or substantially no polymeric or cellulose-based separators. The middle layer 15 separating the two layers 11 and 13 touching the current collectors 3 and 5 can be a gel or a solid-state ceramic layer 15 that allows for the passing of working ions. The assembled battery 1, which may be a “discharged-state” of the battery 1, from the plant can appear as FIG. 1.

The battery 1 can be a cylindrical battery having the electrodes arranged concentrically, or in a rolled configuration in which the cathode 3 and anode 5 are layered and then rolled to form a jelly roll configuration. In some aspects, the battery 1 can have a layered or folded configuration of the electrodes, electrolyte, and/or solid separator layers as shown in FIG. 1. The cathode current collector 3 and cathode material may be collectively called either the cathode 3 or the cathode current collector 3. Similarly, the anode material with the anode current collector 5 can be collectively called either the anode 5 or the anode current collector 5. A catholyte 11 can be in contact with the cathode 3, and an anolyte 13 can be in contact with the anode 5. As described in more detail herein, the catholyte 11 and/or the anolyte 13 can be polymerized or gelled to prevent mixing between the two electrolyte solutions. Alternatively, the battery 1 may have a prismatic battery arrangement having a single cathode and anode.

In some embodiments, the battery 10 can comprise one or more cathodes 3 and one or more anodes 5. When a plurality of cathodes 3 and/or a plurality of anodes 5 are present, the electrodes can be configured in a layered configuration such that the electrodes alternate (e.g., anode, cathode, anode, etc.). Any number of cathodes 3 and/or anodes 5 can be present to provide a desired capacity and/or output voltage. In the jellyroll configuration, the battery 1 may only have one cathode 3 and one anode 5 in a rolled configuration such that a cross section of the battery 1 includes a layered configuration of alternating electrodes.

In an embodiment, a housing may include a molded box or container that is generally non-reactive with respect to the electrolyte solutions in the battery 1, including the catholyte 11 and the anolyte 13. In an embodiment, the housing may include a polypropylene molded box, an acrylic polymer molded box, or the like.

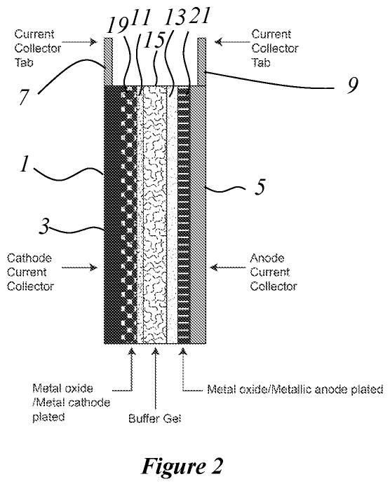

Referring FIG. 2, the first step before the use of the battery 1 can be the application of a formation step where the active ions in the catholyte and anolyte solid-state layers 11 and 13 deposit as respective layers 19 and 21 onto the respective current collector 3 and 5, which can represent the “charged-state” of the battery as depicted in FIG. 2. The battery 1 on formation is then ready to perform work as needed. As the active ions are stored in the catholyte and anolyte solid-state layers 11 and 13 the utilization of the electrodes can be near about 100% on charge and discharge. The working ions in the battery 1, i.e., that allow the charge to balance out in the battery 1 are stored in the middle layer 15, which may be referred to as the “buffer” layer 15. This buffer layer 15 can be solid-state in a gel, a ceramic, or both. Although a solid-state and membrane-less feature is described herein, these features may be applicable to other types like liquid-state and membranes such as bipolar, a sulfonated tetrafluoroethylene based fluoropolymer-copolymer (e.g., available as Nafion, etc.), anion-exchange, etc. On charging the battery 1 from the discharged state, the active ions in the catholyte and anolyte gel layers or plates 11 and 13 onto the cathode and anode current collectors 3 and 5. The deposition may be a metal oxide or metal deposition layers 19 and 21 in a charged state.

Turning to the cathode and anode current collectors 3 and 5, the cathode current collector 3 and the anode current collector 5 may include at least one of: carbon, lead, zinc, stainless steel, copper, nickel, silver, bismuth, titanium, magnesium, aluminum, indium, tin, gold, iron, polypropylene, or a combination thereof. Furthermore, the anode 5 may include zinc, aluminum, indium, bismuth, magnesium, lithium, sodium, copper, nickel, iron, lead, cobalt or a combination thereof. Additionally, the cathode 3 may include manganese dioxide, bismuth oxide, indium oxide, nickel oxide, aluminum oxide, lead oxide, zinc manganese oxide, aluminum manganese oxide, magnesium manganese oxide, lithium manganese oxide, sodium manganese oxide, cobalt oxide, lithium cobalt oxide, zinc cobalt oxide, silver oxide, zinc silver oxide, copper oxide, zinc copper oxide, vanadium oxide, zinc vanadium oxide or a combination thereof. Moreover, either current collector 3 or 5 may include at least one of: a mesh, a foil, a foam, a sponge, a felt, a fibrous cloth, a porous block architecture, or a combination thereof. A conductivity and deposition surface of the cathode current collector 3, the anode current collector 5, or both may be coated with an aqueous or organic dispersion of graphite, expanded graphite, multiwalled carbon nanotubes, single walled carbon nanotubes graphene, graphene oxide or a combination thereof.

The liquid or solid polymerized catholyte 11 may include a liquid or a solid polymerized catholyte solution. The liquid or solid polymerized catholyte solution may include a mixed solution including potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, aluminum chloride, nickel sulfate, nickel chloride, indium sulfate, lithium hexafluorophosphate, aluminum bromide, aluminum acetate, copper sulfate, copper chloride, vanadyl sulfate, vanadium chloride, lead sulfate, lead chloride, sulfuric acid, nitric acid, hydrochloric acid, sodium perchlorate, sodium hexafluorophosphate, lithium perchlorate, lithium bis(trifluoromethanesulfonyl)imide, lithium triflate, lithium bis(oxalato)borate, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrite, lithium hydroxide, lithium perchlorate, lithium oxalate, lithium fluoride, lithium carbonate, lithium bromate, silver nitrate, silver chloride, silver sulfate, a fumed silica, magnesium sulfate, magnesium chloride, aluminum sulfate, aluminum chloride, iron sulfate, iron chloride, polyvinyl alcohol, aluminum nitrate, carboxymethyl cellulose, a xanthum gum, a carrageenan, acrylamide, acrylic acid, polyacrylic acid, potassium acrylate, sodium acrylate, polyacrylamide, potassium persulfate, sodium persulfate, ammonium persulfate, potassium sulfate, sodium sulfate, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, or a combination thereof.

The liquid or solid polymerized anolyte 13 may include a liquid or solid polymerized anolyte solution. The anolyte may include zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, zinc triflate, aluminum sulfate, iron sulfate, aluminum chloride, iron chloride, magnesium chloride, magnesium sulfate, magnesium perchlorate, aluminum perchlorate, aluminum triflate, lithium hexafluorophosphate, aluminum bromide, aluminum acetate, ammonium chloride, sulfuric acid, nitric acid, hydrochloric acid, sodium perchlorate, sodium hexafluorophosphate, lithium perchlorate, lithium bis(trifluoromethanesulfonyl)imide, lithium bis(oxalato)borate, iron triflate, magnesium triflate, 1-methyl-1-propylpyrrolidinium chloride, 1-ethyl-3-methylimidazolium chloride, sodium hydroxide, potassium hydroxide, lithium hydroxide, zinc oxide, aluminum hydroxide, aluminum oxide, iron oxide, magnesium hydroxide, magnesium oxide, copper oxide or copper sulfate dissolved in potassium hydroxide, sodium hydroxide, or lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, bismuth sulfate, bismuth chloride, indium chloride, acrylic acid, acrylamide, polyacrylamide, polyacrylic acid, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

In some embodiments, the zinc (Zn) and manganese dioxide (MnO₂) may be used in the battery system, although the disclosed concepts can be applied to several different cathode 3 and anode 5 chemistries that can have the active ions stored in the respective catholyte and anolyte solid layers 11 and 13 (a gel, a ceramic or both). Examples of other systems include cathodes 3 like manganese dioxide, copper oxide, copper hydroxide, bismuth oxide, nickel oxide, nickel oxyhydroxide, nickel hydroxide, lead, air, sulfur, vanadium oxide, ammonium vanadium oxide, silver oxide, silver, cobalt oxide, permanganates, persulfates, etc. that can be paired with anodes 5 like iron, lithium, sodium, aluminum, copper, cadmium, bismuth, indium, molybdenum, magnesium, potassium, lead and their oxide, sulfide, selenide and tellurium forms. Salts of the respective aforementioned materials can be dissolved into a gel matrix or a ceramic matrix or a combination of both. For example, zinc oxide can be dissolved in alkaline gel electrolytes at high concentrations and manganese sulfate can be dissolved in acidic gel electrolytes at high concentrations. The solubility of the respective metal ion salts is important as that dictates the capacity of the battery 1.

The concentration of the total catholyte solution in liquid or polymerized form may be no more than about 16 molar (M). The concentration of the total anolyte solution in liquid or polymerized form may be no more than about 16M. The temperature of the catholyte and anolyte solutions may be no more than about 200 degrees Celsius (° C.) to form the polymer.

The ceramic buffer may include a ceramic layer 15 including LiSiCON, NaSiCON, combinations of Na, Li, Zn, Ge, V, Si, P, Cl and O, or a redox ion mediating layer. The buffer 15 may be a polymerized solution comprising of sodium acetate, acetic acid, potassium phosphate monobasic, sodium hydroxide, potassium hydrogen phthalate, potassium carbonate, potassium tetraborate, potassium hydroxide, disodium 2,2′,2″,2′″-(Ethane-1,2-diyldinitrilo)tetraacetic acid or ethylenediaminetetraacetic acid (EDTA) dihydrate, tris buffered saline comprising 1.37M sodium chloride, 0.027M potassium chloride, 0.25M tris/tris-hydrogen chloride (HCl)), potassium phosphate monobasic, potassium chloride, hydrochloric acid, boric acid, tris-EDTA, tris hydrochloride, potassium acid phthalate, hydrochloric acid, sodium chloride-tris-EDTA, tris-acetate-EDTA, tris-borate-EDTA, phosphate buffer, borax standard buffer, tris-glycine-sodium dodecyl sulphate (SDS), disodium phosphate, citric acid, monopotassium phosphate, boric acid, diethyl barbituric acid, dihydrogen potassium phosphate, sodium phosphate dibasic, potassium biphthalate, manganese sulfate, lead sulfate, copper sulfate, vanadyl sulfate, zinc sulfate, zinc oxide, aluminum oxide, magnesium oxide, iron oxide dissolved in potassium hydroxide, sodium hydroxide or lithium hydroxide, acrylic acid, polyacrylic acid, acrylamide, polyacrylamide, potassium sulfate, sodium sulfate, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

The buffer layer 15 may have a pH of no more than about 13 and may have a concentrated solution with total concentration of no more than about 16M. The buffer layer 15 may regulate the pH in the battery 1. The battery 1 may be assembled in a discharged state and the battery 1 may be formed by a charge step with a constant current, a constant voltage or a combination thereof.

High voltage properties of the battery 1 can be obtained by pairing acid and alkaline gel electrolytes or solid ceramics or layers that impart acidity and alkalinity to the cathode 3 and anode 5. Cathodes 3 like MnO₂ in acid electrolyte can react at higher potentials (>about 1 V and <2 about V vs Hg|HgO) while anodes 5 like Zn in alkaline electrolyte can react at lowest potentials (>about −1.45 V vs Hg|HgO) to give a high operating potential. In this embodiment, acidic gels with dissolved Mn ions can be used as the catholytes 11 or solid-state layers 11 while alkaline gels with dissolved Zn ion can be used as the anolyte 13 or solid-state layers 13. Charged Mn ions may be deposited as MnO₂ and Zn ions are deposited as Zn. Although not wanting to be bound by theory, the working ions in this chemistry are the sulfate and potassium ions that balance the charge in the system. To prevent neutralization of the two electrolyte gels, a buffer gel 15 or ceramic layer 15 is used as the middle layer 15 that regulates the pH in the system by blocking neutralization. It also acts as the storage for the working ions and releases ions to perform the work during discharge and charge. These working ions remain the same irrespective of the cathode and anode system as long as the electrolyte salts used are the same like potassium and sulfates. However, the working ions can change to sodium, lithium, chlorides, nitrates, di[bis(trifluoromethylsulfonyl)imide], etc. depending on their respective hydroxides or metallic salts used. It can also change depending on ionic liquids or solvents used to transport ions. Other catholytes and anolytes that can be used are ceramic layers 11 and 13 that conduct specific ions like sodium, lithium, potassium, etc. depending on the cathode 3 or anode 5 used in the system. The ceramic layer 15 can be LiSiCON, NaSiCON, LiPON, a K₂O:Al₂O₃ mix or a garnet-type structure containing Li—La—Zr—O or Na—La—Zr-O. The ceramic layer 15 can store the active ions on discharge and plate onto the current collector 3 and/or 5 on charge.

The buffer gels in the system may regulate the pH by reacting with either the acid or alkaline to create their respective conjugates. Numerous buffer solutions exist that can range in pH from less than or equal to about 1 to greater than or equal to about 13. Such buffer solutions can be used as the buffer middle layer 15 or use its salts to create a ceramic composite. Various buffer solutions are depicted in Table 1 below:

TABLE 1
Examples of Buffer Solutions and their pH's

| Buffer Solution | pH |
|---|---|
| Sodium Acetate, Acetic Acid | 4 to 4.5 |
| Potassium Phosphate Monobasic, Sodium Hydroxide | 7 |
| Potassium Hydrogen Phthalate | 4 |
| Potassium Carbonate, Potassium Tetraborate, | 10 |
| Potassium Hydroxide, Disodium EDTA Dihydrate | |
| Tris Buffered Saline (1.37M Sodium Chloride, 0.027M | 7.4 |
| Potassium Chloride, 0.25M Tris/Tris-HCl) | |
| Potassium Phosphate Monobasic, Sodium Hydroxide | 8 |
| Potassium Phosphate Monobasic, Sodium Hydroxide | 7 |
| Potassium Phosphate Monobasic, Sodium Hydroxide | 6 |
| Potassium Acid Phthalate, Sodium Hydroxide | 5 |
| Potassium Chloride, Hydrochloric Acid | 1 |
| Potassium Chloride, Hydrochloric Acid | 2 |
| Boric Acid, Potassium Chloride, Sodium Hydroxide | 9 |
| Tris-EDTA | 8 |
| Tris Hydrochloride | 7.5 |
| Potassium Acid Phthalate, Hydrochloric Acid | 3 |
| Buffer concentrate | 11 |
| Buffer solution concentrate | 6 |
| Sodium Chloride-Tris-EDTA | 8 |
| Tris-Acetate-EDTA, Tris-Borate-EDTA, Phosphate | Varying |
| Buffer, Borax Standard Buffer, Tris-Glycine-SDS | |
| Disodium phosphate, citric acid | 3-8 |
| Citric acid, monopotassium phosphate, boric acid, | 2.6-12 |
| diethyl barbituric acid | |
| Dihydrogen Potassium Phosphate, Sodium Phosphate | 7 |
| Dibasic | |
| Potassium hydrogen phthalate (or Potassium | 5 |
| Biphthalate), Sodium Hydroxide | |

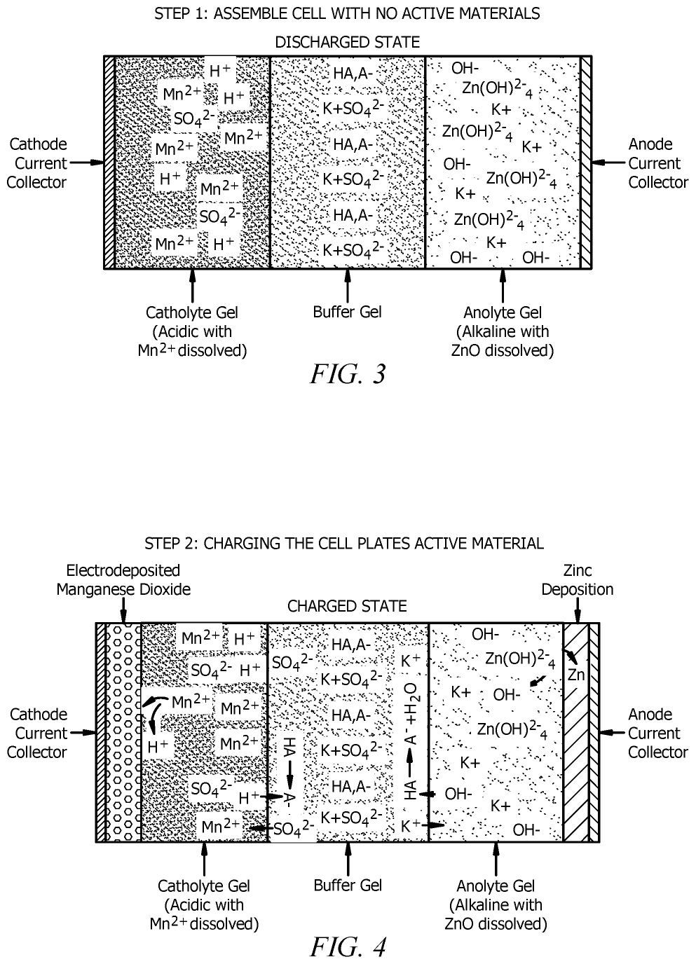

Referring FIGS. 3 and 4, a Zn|MnO₂ high voltage solid-state electrode-less and membrane-less battery depicts the mechanism of the buffer during the discharged and charged state of a battery. The buffering capacity of a middle layer can be increased by providing a concentrated salt system according to the Henderson-Hasselbalch equation. Similarly, the ceramic layers as aforementioned like LiSiCON, NaSiCON, LiPON, a K₂O:Al₂O₃ mix or a garnet-type structure containing Li—La—Zr—O or Na—La—Zr—O, etc. can also be used to transport the working ions between the catholyte and anolyte layers. The buffer layers can also act as the “storage” or “source” of the active material ions. For example, Zn and Mn ions can be mixed in with the buffer gel constituents. On charging of the battery, if additional active ions are required to make the capacity of the battery this layer can act as the source.

Although not wanting to be bound by theory, an exemplary battery system Zn|MnO₂ or the like can deliver its theoretical two electron capacity at high nominal voltage on discharge and store/plate its two electron capacity efficiently on charge. Such a battery assembly can be replicated for other anode|cathode pairings if this performance is desired.

The three layers (catholyte, anolyte, and buffer) can either be a gel, a ceramic or mixture of both if desired. The ceramic layers have been described before where the SiCON refers to the super ion conductor. The LiSiCON or NaSiCON layers can refer to materials containing combinations of Na, Li, Zn, Ge, V, Si, P, Cl and O. Examples include Li₁₄Zn(GeO₄)₄, Li_{3.5}Ge_{0.5}V_{0.5}O₄, Li_{3.5}Si_{0.5}P_{0.5}O₄, Li_{10.42}Ge_{1.5}P_{1.5}Cl_{11.92}, Li_{3.5}Ge_{0.5}P_{0.5}S₄, etc. In the examples Li can be replaced with Na to make NaSiCON materials as well.

For polymeric gels, there are several methods to synthesize these gels but the example method described herein will be the free radical polymerization route. In the free radical polymerization route, a monomer is reacted with the electrolyte solution and initiated for polymerization using an initiator that forms a free radical. Cross-linkers can be used that increase the strength and viscosity of the gels. Cross-linkers can also affect the morphology and deposition thickness of the active material. For those skilled in the art of polymer synthesis can optimize the reaction parameters to obtain optimum morphology and thickness. Examples of monomers include acrylic acid, acrylamide, etc. Examples of cross linkers include N,N′-methylene bis(acrylamide), N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, etc.

Another embodiment is the storage of active ions in the structure of the cathode and anode materials. For example, in a Zn|MnO₂ cell, Zn ions can be stored in the cathode crystal structure framework. Zn ions can be intercalated into the tunneled layers of electrolytic manganese dioxide (EMD, γ-MnO₂) or the interlayers of birnessite (δ-MnO₂). Other polymorphs of MnO₂ can be used to intercalated Zn ions as well like α-MnO₂, β-MnO₂, etc. Spinel structures of Zn—Mn—O can also be used as the cathode material where it acts as the source of Zn ions. Spinel structures exist in a wide range of compositions like ZnₓMn_{y}O_{z}. Examples include ZnMn₂O₄, ZnMnO₃, etc. Similarly, other ions can be stored depending on the chemistry being designed with this electrode-less and membrane-less setup.

To increase the wetting characteristics and absorb more electrolyte within the electrode framework, a sponge-type electrode can be synthesized. Commercially available sponge designs can also be used as wicking layers near the electrode surfaces to improve electrolyte retention and increase active material concentration within the battery. These sponge structures can also be made conductive by incorporating carbon dispersions like carbon nanotubes, graphene, etc. that deposit more active material or capacity per given surface area of the material.

This battery design described herein also has low self-discharge characteristics, better shelf life properties, high utilization of the theoretical capacity of active materials and high rate capability if desired. The working ions, for example K⁺ and SO₄²⁻ in the case of a KOH anolyte and acidic sulfate catholyte, can be efficiently stored in the middle interlayer like the buffer gel and utilized during the battery operation that relates to the cycling rate. As the working active ions are stored in the layers, there is no problem of active material dissolution or degradation which is commonly seen in the traditional battery designs.

As disclosed herein, the battery cannot only be electrode-less, but membrane-less as well. Although an example is shown for Zn|MnO₂ batteries, this design can be replicated and applied to other anode and cathode combinations.

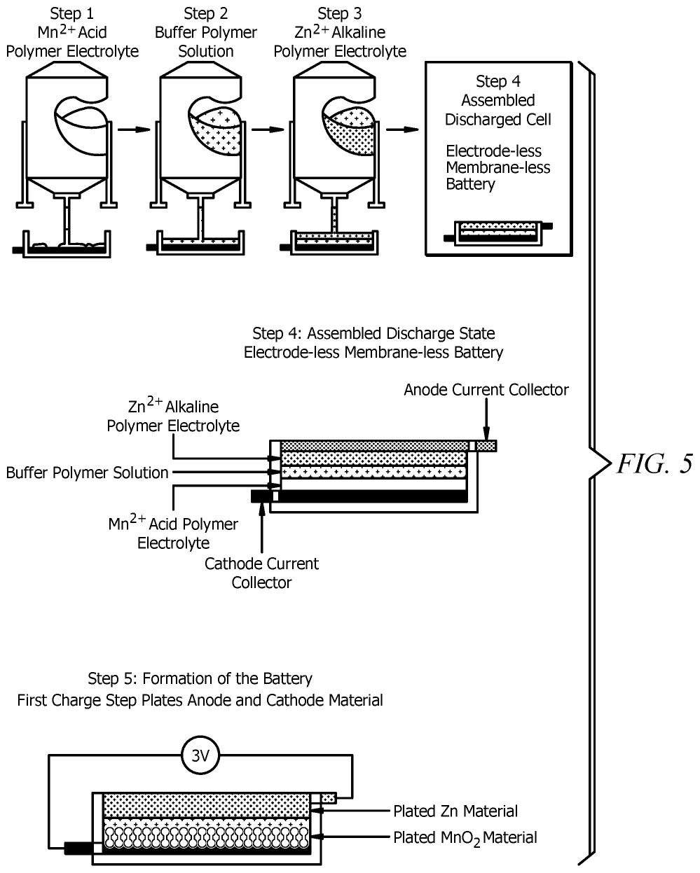

The battery described in the examples can be easily mass manufactured with a very simplified process. This is schematically shown in FIG. 5. In one exemplary method, the electrode-less and membrane-less battery, can be made by: forming a liquid or solid polymerized catholyte including dissolved active ions; forming a liquid or solid polymerized anolyte including dissolved active ions; forming a ceramic or solid polymerized buffer including active and working ions; layering the buffer between the catholyte the anolyte; disposing a cathode current collector in contact with the catholyte; and disposing an anode current collector in contact with the anolyte. The battery manufacturing process can reduce the number of energy and cost intensive steps, which reduces the carbon footprint of the battery in the overall life cycle assessment analysis.

In some embodiments, one or both of the anolyte and the catholyte can be gelled in the battery. The polymerization process can be performed with any electrolyte, including any of those described herein (e.g., organic, aqueous, ionic liquid, water in salt, etc.). A number of polymerization techniques can be used to form the gelled/solid electrolyte—for example, step-growth, chain-growth, emulsion polymerization, solution polymerization, suspension polymerization, precipitation polymerization, photopolymerization and others. Once the gelled/solid electrolytes are formed through the polymerization step, they can be combined in a single battery housing as described herein. The battery can use separators or be membrane-less or separator-less.

As described herein, the electrolyte can be polymerized or gelled to form a polymer gel electrolyte (PGE) for the catholyte and/or the anolyte. The resulting PGE can be in a semi-solid state that resists flowing within the battery. For example, the PGE can comprise an inert hydrophilic polymer matrix impregnated with aqueous electrolyte. The electrolyte can be polymerized using any suitable techniques. In an embodiment, a method of forming a PGE can begin with selecting a monomer material for the PGE. The monomer can be polar vinyl monomer selected from the group consisting of acrylic acid, vinyl acetate, acrylate esters, vinyl isocyanate, acrylonitrile, or any combinations thereof. The aqueous electrolyte component can then be selected, and can include any of the components described above with respect to the electrolyte. An initiator can be added to start the polymerization process. In some embodiments, a cross-linker can be used in the electrolyte composition to further cross-link the polymer matrix in order to form the PGE. The monomer in the composition (e.g., a polar vinyl monomer) can be present in an amount of between about 5 percent (%) to about 50% by weight, the initiator can be present in an amount of between about 0.001 weight percent (wt. %) to about 0.1 wt. %, and the cross-linker can be present in an amount of between 0 to 5 wt. %.

In some embodiments, the PGE can be formed in-situ, which refers to the introduction of the electrolyte as a liquid into the housing followed by subsequent polymerization to form the PGE within the housing. This method can allow the electrolyte composition to soak into the void spaces, the anode, and/or the cathode prior to fully polymerizing to form the PGE. In some embodiments, a vacuum (e.g., a pressure less than atmospheric pressure) can be created within the housing upon introduction of the electrolyte into the corresponding compartment. The vacuum can serve to remove air and allow the electrolyte to penetrate the cathode 3, the anode 5, and/or the various void spaces within the battery 1. In some embodiments, the vacuum can be between about 10 and 29.9 inches of mercury (0.34 and 1.0 bar) or between about 20 and about 29.9 inches of mercury (0.68 and 1.0 bar) vacuum. The use of the vacuum can help to avoid the presence of air pockets within the battery 10 prior to the full polymerization of the electrolyte. In some embodiments, the electrodes can be soaked in the electrolyte solution for between 1-120 minutes at a temperature of between 0° C. to 30° C. prior to full polymerization of the electrolyte to allow the electrolyte to impregnate the electrodes (cathode 3 and anode 5). Once the electrolyte is polymerized, the battery 1 can be allowed to rest prior to use. In some embodiments, the battery 1 can be allowed to rest for between 5 minutes and 24 hours.

In order to help impregnate the electrodes with the electrolyte, the electrodes can be pre-soaked with the selected electrolyte solution prior to polymerizing the electrolyte. This can be performed by soaking the electrodes in the electrolyte (e.g., in a catholyte or anolyte separately) outside of the battery or housing, and then placing the pre-soaked electrodes into the housing to construct the battery. In some embodiments, an electrolyte that does not contain a polymer or gelling agent can be introduced into the battery to soak the electrodes in-situ. This can include the use of a vacuum to assist in impregnating the electrodes. The electrodes can be soaked for between about 1 minute and 24 hours. In some embodiments, the soaking can be carried out over a plurality of cycles in which the battery is filled with the electrolyte and allowed to soak, drained, refilled and allowed to soak, followed by draining a desired number of times. Once the electrodes are soaked and impregnated with the electrolyte, the electrolyte containing the polymer and polymerization agents (e.g., an initiator, cross-linking agent, etc.) can be introduced into the housing and allowed to polymerize to form the final battery.

The composition of the electrolyte, the monomer material, the initiator, and the conditions of the formation (e.g., temperature, etc.) can be selected to provide a desired polymerization time to allow the electrolyte composition to properly soak the components of the batter to absorb and penetrate into the electrodes. The temperature can be controlled to control the polymerization process, where relatively colder temperatures can inhibit or slow the polymerization, and relatively warmer temperatures can decrease the polymerization time or accelerate the polymerization process. In addition, an increase in an alkaline electrolyte component (e.g., a hydroxide) can decrease the polymerization time, and an increase in the initiator concentration will decrease the polymerization time. Suitable polymerization times can be between 1 minute and 24 hours, based on the composition of the electrolyte solution and the temperature of the reaction.

In some embodiments, the anolyte and/or the catholyte can be formed via a gelation process, such as a free radical polymerization technique, wherein acrylic acid can be used as the monomer, for example. Acrylic acid can be mixed with either the anolyte or catholyte until it is substantially dissolved. A cross-linker like N,N′-methylenebisacrylamide (MBA) can be used to increase the strength of the polymer. For the anolyte, the process of mixing the acrylic acid with the MBA can be usually done at relatively cold temperatures because of the heat generated in the reaction. However, for the catholyte, the mixture of acrylic acid and MBA can be heated between 50-200° C. The polymerization can be initiated through the addition of an initiator like a persulfate salt, such as potassium persulfate, sodium persulfate, ammonium persulfate, or any combination thereof. The electrolyte additives (e.g., anolyte additive, catholyte additive) can be included during the gelation process. Ionomers can also be added during the gelation process. Nonlimiting examples of ionomers that can be added to the electrolyte during the gelation process include sulfonated tetrafluoroethylene based fluoropolymer-copolymer solutions which are made from perfluorosulfonic acid (PFSA)/polytetrafluoroethylene (PTFE) copolymer in the acid form or anion exchange ionomers with polyaromatic polymer.

As an example of a polymerization process, a mixture of acrylic acid, N,N′-methylenebisacrylamide, and alkaline solution can be created at a temperature of around 0° C. Any additives can then be added to the solution (e.g., gassing inhibitors, additional additives as described herein, etc.). For example, zinc oxide, when used in the electrolyte, can be dissolved in the alkaline solution after mixing the precursor components, where the zinc oxide can beneficial during the electrochemical cycling of the anode. To polymerize the resulting mixture an initiator such as potassium persulfate can be added to initiate the polymerization process and form a solid or semi-solid polymerized electrolyte (e.g., a PGE). The resulting polymerized electrolyte can be stable over time once the polymerization process has occurred.

As an example, a PGE described herein can be made through a free radical polymerization process. In an embodiment, acrylic acid (AA) can be used as a monomer with N,N′-methylenebisacrylamide (MBA) as the cross-linker and potassium persulfate (K₂S₂O₈) as the initiator. When preparing the anolyte, an alkaline electrolyte such as KOH can be added to this process, which can be embedded in the anolyte gel/polymer framework. The addition of alkaline electrolyte to AA results in neutralization, which reduces the concentration of the alkaline electrolyte in the polymeric gel. Differing alkaline electrolyte concentrations can alter the gelation time. Higher alkaline electrolyte concentrations usually result in faster gelation, while lower alkaline electrolyte concentrations take longer times. Further, initiator concentration can affect the gelation process. Furthermore, the viscosity of the gel can be tuned by altering the monomer and MBA concentration, which can also affect ionic conductivity. Similarly, when preparing the catholyte, an acidic electrolyte such as sulfuric acid can be added to this process, which can be embedded in the catholyte gel/polymer framework.

In some embodiments, an ionomer gelation layer can also be made, wherein the ionomer gelation layer can separate the catholyte and anolyte solutions or gels. The gelation process for forming the ionomer gelation layer is substantially similar to the gelation process of forming the anolyte and/or catholyte gels as described herein, wherein the ionomers are added to the electrolyte during the gelation process. The ionomer gels (e.g., ionomer gelation layers) can also contain additives such as potassium sulfate, sodium sulfate, ammonium sulfate, or any combination thereof. Ionomer resins can also be used in the gelation process to produce an ionomer gelation layer.

The polymerization process can occur prior to the construction of the battery or after the cell is constructed. In some embodiments, the electrolyte can be polymerized and placed into a tray to form a sheet. Once polymerized, the sheet can be cut into a suitable size and shape and one or more layers can be used to form the electrolyte in contact with the anode. When a pre-formed PGE is used, additional liquid electrolyte can be introduced into the battery and/or the electrodes can be pre-soaked with the electrolyte prior to constructing the battery.

In some embodiments, the PGE can be formed using an aqueous electrolyte, organic electrolyte, ionic liquid, water in salt electrolyte, and the like. In some embodiments, an aqueous electrolyte can be used for the catholyte and/or anolyte and gelled to form an aqueous hydrogel as the PGE. In some embodiments, aqueous hydrogels can be made through a free radical polymerization process. For example, when preparing the anolyte, acrylic acid (AA) can be selected as the monomer with N,N′-methylenebisacrylamide (MBA) as the cross-linker and potassium persulfate as the initiator. In aqueous alkaline anolytes, a suitable hydroxide (e.g., potassium hydroxide (KOH), sodium hydroxide, lithium hydroxide, etc.) can be used to form the electrolyte. The hydroxide can be encapsulated in a hydrogel network by neutralizing the hydroxide with the AA. To create a hydrogel, the monomer can be combined with any cross-linker until the cross-linker is dissolved. Separately, an amount of the hydroxide can be cooled to slow the reaction. In some embodiments in which the anolyte is an aqueous electrolyte, the hydroxide can be cooled to a temperature below about 10° C., below about 5° C., or below about 0° C. The mixed solution of the monomer and any cross-linker can then be added drop-wise to the chilled solution of the hydroxide as the neutralization reaction releases heat. To gel the resulting mixture of the hydroxide, monomer, and cross-linker, an initiator such as potassium persulfate can be added. The mixture can then be allowed to form a PGE. The amounts and concentrations of the ingredients can be varied to obtain varying mechanical strengths of the hydrogels. Similarly, when preparing the catholyte, an acidic electrolyte such as sulfuric acid can be encapsulated in a hydrogel network.

Electrolytes comprising ionic liquids can also be used to form PGEs, including any of the ionic liquid described herein. To form a PGE using an ionic liquid, a solution of any additives, which can be in a suitable solvent, can be prepared and a monomer can be added. The monomer can be any suitable monomer. For example, acrylamide can be used as a polymerization agent for ionic liquids. To this solution, the ionic liquid along with the additive solution can be mixed along with an initiator. Any suitable initiator for use with the polymerization agent can be used. For example, azobisisobutyronitrile can be used with acrylamide. The initiator can be added in a suitable amount such about 1 wt. % of the polymerization agent. This final solution can then be heated to form a polymerized gel.

Organic electrolytes comprising a salt dissolved in an organic solvent can also be gelled to form an anolyte and/or catholyte. As an example, lithium-ion conducting electrolytes can be gelled using a number of polymerization techniques such as ring-opening polymerization, photo-initiated radical polymerization, UV-initiated radical polymerization, thermal-initiated polymerization, in-situ polymerization, UV-irradiation, electrospinning, and others. The lithium electrolyte can comprise lithium hexafluorophosphate (LiPF₆), lithium perchlorate, lithium bis(trifluoromethanesulfonyl)imide, lithium bis(oxalato)borate, and combinations thereof in an organic solvent such as ethylene carbonate, dimethyl carbonate, propylene carbonate, diethyl carbonate, ethyl methyl carbonate, and combinations thereof. An exemplary mixture can include 1 M LiPF₆ mixed in a solvent mixture of ethylene carbonate and dimethyl carbonate. Other solvents also exist that can be used as a mixture to reduce the flammability of the organic electrolyte.

The organic electrolyte can be gelled by mixing the selected salts with the organic solvent. A gelling agent can then be added along with an initiator. The gelling agent can be added in an amount between about 0.1 to about 5 wt. % of the mixture, and the initiator can be added in an amount of between about 0.01 to about 1 wt. % of the mixture. In some embodiments, a suitable gelling agent for an organic electrolyte can comprise pentaerythritol tetraacrylate and the initiator can comprise azodiisobutyronitrile. The resulting mixture can be gelled (e.g., polymerized) by heating the mixture to about 50-90° C., or to about 70° C. and holding for 1-24 hours.

For an aqueous electrolyte which is acidic in nature, such as the catholyte, the polymerization can be carried out using a number of processes. In an embodiment, a method for making a solid state gelled aqueous acid electrolyte can comprise the addition of acrylamide to a solution comprising manganese sulfate, H₂SO₄, ammonium sulfate, potassium permanganate, and/or sulfuric acid. A gelling agent comprising acrylamide can be added to the solution and mixed at a temperature between about 70-90° C. for at least an hour until the solution is homogenous. After the solution is mixed well, then a cross-linker and initiator can be added to the solution and mixed between 2-48 hours until the solution gels.

Gels or polymeric membranes containing Li SiCON and NaSiCON can be made using the procedures described herein for the formation of PGEs and/or ionomer gelation layers, by using raw materials used in making ceramic separators.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The anolyte, catholyte and buffer gels are synthesized using a free radical polymerization route. The anolyte gel is prepared by first dissolving 0.125 gram (g) of n-butylamine (MBA) in 5 milliliter (ml) of acrylic acid (AA). In the next step, chilled solution of potassium hydroxide (KOH) saturated with zincate [ZnO dissolved in KOH] is added to the mixture of MBA and AA which results in a neutralization reaction. Starting with a higher concentration of KOH often obtains the desired concentration as the neutralization reaction results in lowering KOH concentration. The mixture of KOH saturated with zincate, MBA and AA is mixed thoroughly until a clear, homogenous solution and at room temperature. For the final step, 500 microliter (uL) of 4 wt. % potassium persulfate (K₂S₂O₈) solution is added to initiate the polymerization reaction. The solution is quickly poured into a polytetrafluoroethylene petri dish to cast the alkaline film with desired thickness. The strength, viscosity and crosslinking density of the gel can be optimized and varied by changing the concentrations and amounts. The numbers given in this example are a representation of one type of gels made, while those who are skilled in the art can vary the amounts and concentrations or even the monomer and crosslinker to obtain different gels which maybe more conducive to other battery chemistries. If solubility limit of zincate has exceeded in KOH then additional Zn 2+ ions can be either incorporated in the buffer or catholyte gel.

The acid gel is prepared by first dissolving 0.025 g of MBA in 5 ml of AA. In the next step, solution of 1M manganese(II) sulfate (MnSO₄) and 1M sulfuric acid (H₂SO₄) is added to the mixture of MBA and AA. In the final step, 1% weight per volume (w/v) of K₂S₂O₈ solution is added and stirred until the final solution is homogenous. This solution is poured into a polytetrafluoroethylene petri dish and heated in an oven at 1250° C. for 10 minutes (mins). Similarly, the amounts and concentrations of the monomer, crosslinker and acid concentration can be varied. The manganese concentration can be increased if desired to increase the capacity in the battery. Zinc sulfate can also be incorporated if desired to increase Zn 2+ ions in the system.

The buffer gel is synthesized using the same approach used for preparing the acid and alkaline gels. The buffer solutions are made internally. The pH 5 buffer comprised of 3.65M potassium acetate and 1.35M acetic acid, pH 1 buffer comprised of 2M potassium chloride and of hydrochloric acid and pH 9 buffer comprised of 2M of boric acid and 1M of sodium hydroxide. Sodium acetate, sodium chloride and potassium hydroxide can also be used in the respective buffer solutions. This buffer solution (25 ml) is mixed with 0.125 g of MBA and 5 ml of AA till the final solution is homogenous. In the final step, 1% w/v of K₂S₂O₈ solution is added and stirred until the final solution is homogenous. This solution is poured into a polytetrafluoroethylene petri dish and heated in an oven at 1250° C. for 10 mins. Zinc and manganese ions can be incorporated into the buffer gel if required. The other working ions like K⁺ and SO₄²⁻ can also be incorporated in the buffer gel to help with the rate capabilities of the battery.

These gels are in this example system. However, this example can be easily translated to other systems if desired. Even ceramic membranes like NaSICON, LiSiCON, etc. can be used that transfer the redox mediating ions.

### Example 2

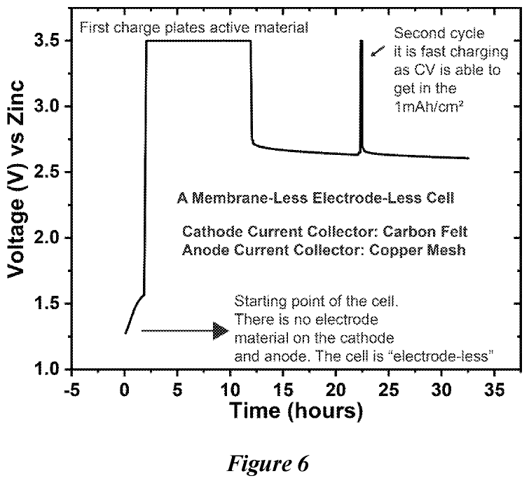

The battery is assembled according to the schematic shown in FIG. 1. It is in the discharged state with carbon felt used as the cathode current collector while copper mesh is used as the anode current collector. The gels as described in Example 1 are used as the layers to assemble the battery. The open circuit voltage (OCV) of this battery is ˜1.25 V, which is very high for a battery containing no active materials on the current collector. This OCV is shown in FIG. 6.

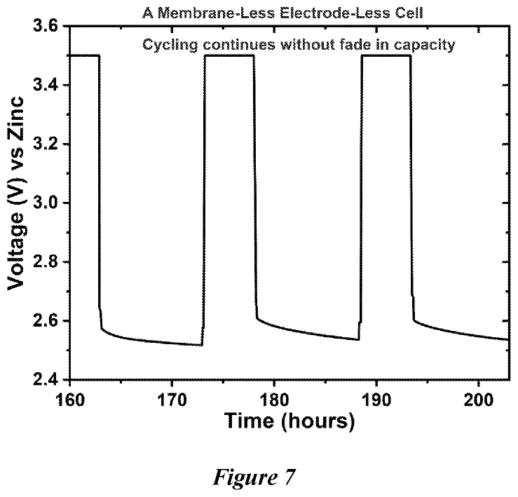

To form the battery, it is first subjected to constant voltage (CV) charge at 3.5V. This formation step results in oxidation at the cathode and reduction at the anode. The battery can also be formed at 3V if desired. Charging at 3V leads to higher energy efficiencies. The battery after charging at 3.5V increases the OCV to −2.7V. This means that MnO₂ and Zn plates on the cathode and anode, respectively. On discharge, the battery delivers its capacity of 1 milliamp per hour per centimeter squared (mAh/cm²) at >2.6V. This is the highest voltage for an electrode-less membrane-less battery. After discharge the battery can be fast charged to obtain 1 mAh/cm² within minutes and then is discharged again at the same nominal voltage of >2.6V without any loss in voltage. This battery cycles very stably without loss in capacity for >200 h as shown in FIG. 7.

### Example 3

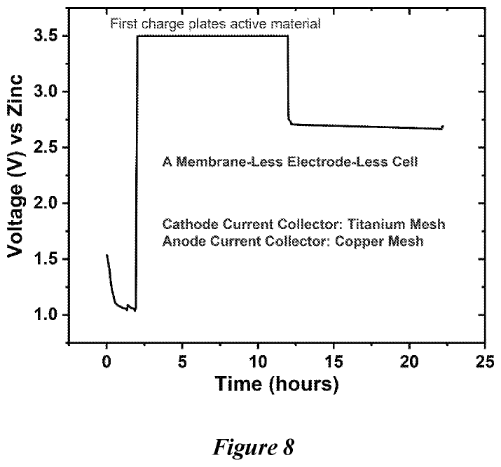

Carbon felt can be very thick, which can reduce the energy density of the battery. To increase the energy density by reducing the volume (or thickness) of the battery, thin titanium mesh is used as the current collector for the cathode. On the titanium mesh, a thin layer of 95% carbon nanotubes and 5% polytetrafluoroethylene is pasted. This thin layer acts as the deposition surface for MnO₂. This battery is also assembled in the discharged state as shown in FIG. 1 which shows an initial OCV of ˜1.5V as shown in FIG. 8.

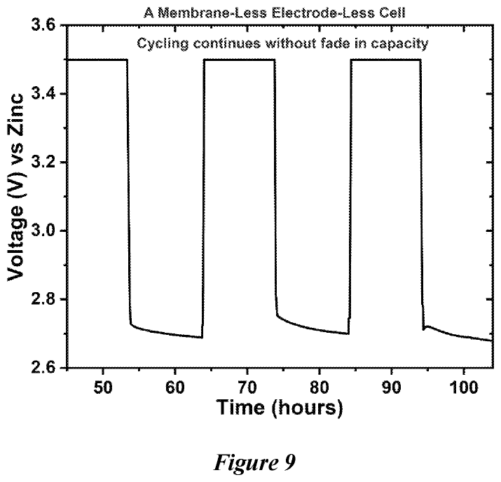

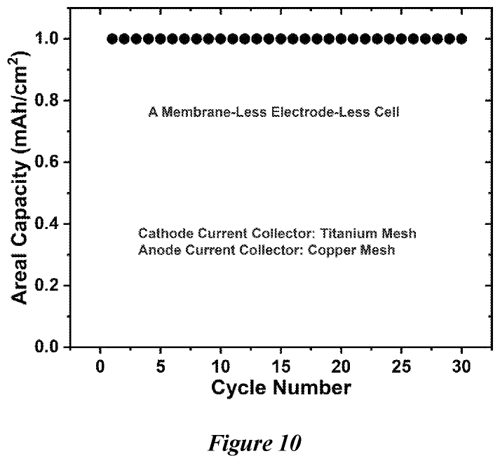

This battery is also charged at CV at 3.5V to form up the electrodes. This battery is cycled in the similar way as the battery described in point 2. The nominal discharge for this battery is also >2.6V. This battery cycled very stably for >100 h with no capacity fade as shown in FIG. 9. The capacity retention of this battery is also 100% with near 100% coulombic efficiency as shown in FIG. 10. To increase the Mn and Zn concentration in the battery, sponge-type designs can be incorporated with the electrodes that wick more Mn and Zn ions thus increasing the capacity of the battery.

Having described various systems and methods herein, certain embodiments can include, but are not limited to:

In a first aspect, an electrode-less and membrane-less battery comprises: a cathode current collector; an anode current collector; a liquid or solid polymerized catholyte comprising dissolved active ions in contact with the cathode; a liquid or solid polymerized anolyte comprising dissolved active ions in contact with the anode; and a ceramic or solid polymerized buffer comprising active and working ions disposed between the catholyte and the anolyte.

A second aspect can include the battery of the first aspect, wherein the cathode current collector and the anode current collector comprise at least one of: carbon, lead, zinc, a stainless steel, copper, nickel, silver, bismuth, titanium, magnesium, aluminum, indium, tin, gold, iron, a polypropylene, or a combination thereof.

A third aspect can include the battery of the first or second aspect, wherein the current collector comprises at least one of: a mesh, a foil, a foam, a sponge, a felt, a fibrous cloth, a porous block architecture, or a combination thereof.

A fourth aspect can include the battery of any one of the first to third aspects, wherein the catholyte comprises a liquid or a solid polymerized catholyte solution, and wherein the liquid or solid polymerized catholyte solution comprises a mixed solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, aluminum chloride, nickel sulfate, nickel chloride, indium sulfate, lithium hexafluorophosphate, aluminum bromide, aluminum acetate, copper sulfate, copper chloride, vanadyl sulfate, vanadium chloride, lead sulfate, lead chloride, sulfuric acid, nitric acid, hydrochloric acid, sodium perchlorate, sodium hexafluorophosphate, lithium perchlorate, lithium bis(trifluoromethanesulfonyl)imide, lithium triflate, lithium bis(oxalato)borate, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrite, lithium hydroxide, lithium perchlorate, lithium oxalate, lithium fluoride, lithium carbonate, lithium bromate, silver nitrate, silver chloride, silver sulfate, a fumed silica, magnesium sulfate, magnesium chloride, aluminum sulfate, aluminum chloride, iron sulfate, iron chloride, polyvinyl alcohol, aluminum nitrate, carboxymethyl cellulose, a xanthum gum, a carrageenan, acrylamide, acrylic acid, polyacrylic acid, potassium acrylate, sodium acrylate, polyacrylamide, potassium persulfate, sodium persulfate, ammonium persulfate, potassium sulfate, sodium sulfate, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, or a combination thereof.

A fifth aspect can include the battery of any one of the first to fourth aspects, wherein the concentration of the total catholyte solution in liquid or polymerized form is of no more than about 16M.

A sixth aspect can include the battery of any one of the first to fifth aspects, wherein the anolyte comprises a liquid or solid polymerized anolyte solution, and wherein the anolyte comprises zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, zinc triflate, aluminum sulfate, iron sulfate, aluminum chloride, iron chloride, magnesium chloride, magnesium sulfate, magnesium perchlorate, aluminum perchlorate, aluminum triflate, lithium hexafluorophosphate, aluminum bromide, aluminum acetate, ammonium chloride, sulfuric acid, nitric acid, hydrochloric acid, sodium perchlorate, sodium hexafluorophosphate, lithium perchlorate, lithium bis(trifluoromethanesulfonyl)imide, lithium bis(oxalato)borate, iron triflate, magnesium triflate, 1-methyl-1-propylpyrrolidinium chloride, 1-ethyl-3-methylimidazolium chloride, sodium hydroxide, potassium hydroxide, lithium hydroxide, zinc oxide, aluminum hydroxide, aluminum oxide, iron oxide, magnesium hydroxide, magnesium oxide, copper oxide, copper sulfate dissolved in potassium hydroxide, sodium hydroxide, or lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, bismuth sulfate, bismuth chloride, indium chloride, acrylic acid, acrylamide, polyacrylamide, polyacrylic acid, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

A seventh aspect can include the battery of any one of the first to sixth aspects, wherein the concentration of the total anolyte solution in liquid or polymerized form is no more than about 16M.

An eighth aspect can include the battery of any one of the first to seventh aspects, wherein the temperature of the solutions is no more than about 200° C. to form the polymer.

A ninth aspect can include the battery of any one of the first to eighth aspects, wherein the ceramic buffer comprises a ceramic layer comprising LiSiCON, NaSiCON, combinations of Na, Li, Zn, Ge, V, Si, P, Cl and O, or a redox ion mediating layer.

A tenth aspect can include the battery of any one of the first to ninth aspects, wherein the buffer is a polymerized solution comprising of sodium acetate, acetic acid, potassium phosphate monobasic, sodium hydroxide, potassium hydrogen phthalate, potassium carbonate, potassium tetraborate, potassium hydroxide, disodium EDTA dihydrate, tris buffered saline comprising 1.37M sodium chloride, 0.027M potassium chloride, and 0.25M tris/tris-HCl, potassium phosphate monobasic, potassium chloride, hydrochloric acid, boric acid, tris-EDTA, tris hydrochloride, potassium acid phthalate, hydrochloric acid, sodium chloride-tris-EDTA, tris-acetate-EDTA, tris-borate-EDTA, phosphate buffer, borax standard buffer, tris-glycine-SDS, disodium phosphate, citric acid, monopotassium phosphate, boric acid, diethyl barbituric acid, dihydrogen potassium phosphate, sodium phosphate dibasic, potassium hydrogen phthalate, potassium biphthalate, manganese sulfate, lead sulfate, copper sulfate, vanadyl sulfate, zinc sulfate, zinc oxide, aluminum oxide, magnesium oxide, iron oxide dissolved in potassium hydroxide, sodium hydroxide or lithium hydroxide, acrylic acid, polyacrylic acid, acrylamide, polyacrylamide, potassium sulfate, sodium sulfate, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

An eleventh aspect can include the battery of any one of the first to tenth aspects, wherein the buffer layer has a pH of no more than about 13.

A twelfth aspect can include the battery of any one of the first to eleventh aspects, wherein the buffer layer is a concentrated solution with total concentration of no more than about 16M.

A thirteenth aspect can include the battery of any one of the first to twelfth aspects, wherein the buffer layer regulates the pH in the battery.

A fourteenth aspect can include the battery of any one of the first to thirteenth aspects, wherein a conductivity and deposition surface of the anode current collector, the cathode current collector, or both coated with an aqueous or organic dispersion of graphite, expanded graphite, multiwalled carbon nanotubes, single walled carbon nanotubes graphene, graphene oxide or a combination thereof.

A fifteenth aspect can include the battery of any one of the first to fourteenth aspects, wherein the battery is assembled in a discharged state.

A sixteenth aspect can include the battery of any one of the first to fifteenth aspects, wherein the battery is formed by a charge step with a constant current, a constant voltage or a combination thereof.

A seventeenth aspect can include the battery of any one of the first to sixteenth aspects, wherein the formed battery can comprise an anode of zinc, aluminum, indium, bismuth, magnesium, lithium, sodium, copper, nickel, iron, lead, cobalt or a combination thereof.

An eighteenth aspect can include the battery of any one of the first to sixteenth aspects, wherein the formed battery can comprise a cathode of manganese dioxide, bismuth oxide, indium oxide, nickel oxide, aluminum oxide, lead oxide, zinc manganese oxide, aluminum manganese oxide, magnesium manganese oxide, lithium manganese oxide, sodium manganese oxide, cobalt oxide, lithium cobalt oxide, zinc cobalt oxide, silver oxide, zinc silver oxide, copper oxide, zinc copper oxide, vanadium oxide, zinc vanadium oxide or a combination thereof.

In a nineteenth aspect, a method of forming an electrode-less and membrane-less battery, comprises: forming a liquid or solid polymerized catholyte comprising dissolved active ions; forming a liquid or solid polymerized anolyte comprising dissolved active ions; forming a ceramic or solid polymerized buffer comprising active and working ions; layering the buffer between the catholyte and the anolyte; disposing a cathode current collector in contact with the catholyte; and disposing an anode current collector in contact with the anolyte.

A twentieth aspect can include the method of the nineteenth aspect, wherein the cathode current collector and the anode current collector comprise at least one of: carbon, lead, zinc, stainless steel, copper, nickel, silver, bismuth, titanium, magnesium, aluminum, indium, tin, gold, iron, polypropylene, or a combination thereof.

A twenty first aspect can include the method of the nineteenth or twentieth aspect, wherein the current collector is in the form of at least one of: a mesh, a foil, a foam, a sponge, a felt, a fibrous cloth, a porous block architecture, or a combination thereof.

A twenty second aspect can include the method of any one of the nineteenth to twenty first aspects, wherein the catholyte is a liquid or a solid polymerized catholyte solution, and wherein the liquid or solid polymerized catholyte solution comprises a mixed solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, aluminum chloride, nickel sulfate, nickel chloride, indium sulfate, lithium hexafluorophosphate, aluminum bromide, aluminum acetate, copper sulfate, copper chloride, vanadyl sulfate, vanadium chloride, lead sulfate, lead chloride, sulfuric acid, nitric acid, hydrochloric acid, sodium perchlorate, sodium hexafluorophosphate, lithium perchlorate, lithium bis(trifluoromethanesulfonyl)imide, lithium triflate, lithium bis(oxalato)borate, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium bromate, silver nitrate, silver chloride, silver sulfate, a fumed silica, magnesium sulfate, magnesium chloride, aluminum sulfate, aluminum chloride, iron sulfate, iron chloride, polyvinyl alcohol, aluminum nitrate, carboxymethyl cellulose, a xanthum gum, a carrageenan, acrylamide, acrylic acid, polyacrylic acid, potassium acrylate, sodium acrylate, polyacrylamide, potassium persulfate, sodium persulfate, ammonium persulfate, potassium sulfate, sodium sulfate, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, or a combination thereof.

A twenty third aspect can include the method of any one of the nineteenth to twenty second aspects, wherein the concentration of the total catholyte solution in liquid or polymerized form is no more than about 16 M.

A twenty fourth aspect can include the method of any one of the nineteenth to twenty third aspects, wherein the anolyte is a liquid or solid polymerized anolyte solution, and wherein the anolyte comprises zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, zinc triflate, aluminum sulfate, iron sulfate, aluminum chloride, iron chloride, magnesium chloride, magnesium sulfate, magnesium perchlorate, aluminum perchlorate, aluminum triflate, aluminum chloride, lithium hexafluorophosphate, aluminum bromide, aluminum acetate, ammonium chloride, sulfuric acid, nitric acid, hydrochloric acid, sodium perchlorate, sodium hexafluorophosphate, lithium perchlorate, lithium bis(trifluoromethanesulfonyl)imide, lithium bis(oxalato)borate, iron triflate, magnesium triflate, 1-methyl-1-propylpyrrolidinium chloride, 1-ethyl-3-methylimidazolium chloride, sodium hydroxide, potassium hydroxide, lithium hydroxide, zinc oxide, aluminum hydroxide, aluminum oxide, iron oxide, magnesium hydroxide, magnesium oxide, copper oxide or copper sulfate dissolved in potassium hydroxide or sodium hydroxide or lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, bismuth sulfate, bismuth chloride, indium chloride, acrylic acid, acrylamide, polyacrylamide, polyacrylic acid, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

A twenty fifth aspect can include the method of any one of the nineteenth to twenty fourth aspects, wherein a concentration of the total anolyte solution in liquid or polymerized form is no more than about 16M.

A twenty sixth aspect can include the method of any one of the nineteenth to twenty fifth aspects, wherein the temperature of the solutions is no more than about 200° C. to form the polymer.

A twenty seventh aspect can include the method of any one of the nineteenth to twenty sixth aspects, wherein the ceramic layer is LiSiCON, NaSiCON, combinations of Na, Li, Zn, Ge, V, Si, P, Cl and O, or a redox ion mediating layer.

A twenty eighth aspect can include the method of any one of the nineteenth to twenty seventh aspects, wherein the buffer is polymerized solution comprising of sodium acetate, acetic acid, potassium phosphate monobasic, sodium hydroxide, potassium hydrogen phthalate, potassium carbonate, potassium tetraborate, potassium hydroxide, disodium EDTA Dihydrate, tris buffered saline comprising 1.37M sodium chloride, 0.027M potassium chloride, and 0.25M tris/tris-HCl, potassium phosphate monobasic, potassium chloride, hydrochloric acid, boric acid, tri s-ED TA, tris hydrochloride, potassium acid phthalate, hydrochloric acid, sodium chloride-tris-EDTA, tris-acetate-EDTA, tris-borate-EDTA, phosphate buffer, borax standard buffer, tris-glycine-SDS, disodium phosphate, citric acid, monopotassium phosphate, boric acid, diethyl barbituric acid, dihydrogen potassium phosphate, sodium phosphate dibasic, potassium hydrogen phthalate or potassium biphthalate, manganese sulfate, lead sulfate, copper sulfate, vanadyl sulfate, zinc sulfate, zinc oxide, aluminum oxide, magnesium oxide, iron oxide dissolved in potassium hydroxide, sodium hydroxide, or lithium hydroxide, acrylic acid, polyacrylic acid, acrylamide, polyacrylamide, potassium sulfate, sodium sulfate, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

A twenty ninth aspect can include the method of any one of the nineteenth to twenty eighth aspects, wherein the buffer layer has a pH of no more than about 13.

A thirtieth aspect can include the method of any one of the nineteenth to twenty ninth aspects, wherein the buffer layer is a concentrated solution with total concentration of no more than about 16M.

A thirty first aspect can include the method of any one of the nineteenth to thirtieth aspects, wherein the buffer layer regulates the pH in the battery.

A thirty second aspect can include the method of any one of the nineteenth to thirty first aspects, wherein a conductivity and deposition surface of the anode current, the cathode current collector, or both are enhanced by coating it with an aqueous or organic dispersion of graphite, an expanded graphite, multiwalled carbon nanotubes, a single walled carbon nanotubes graphene, a graphene oxide or a combination thereof.

A thirty third aspect can include the method of any one of the nineteenth to thirty second aspects, wherein the battery is assembled in a discharged state.

A thirty fourth aspect can include the method of any one of the nineteenth to thirty third aspects, wherein the battery is formed by a charge step with a constant current, a constant voltage or a combination thereof.

A thirty fifth aspect can include the method of any one of the nineteenth to thirty fourth aspects, wherein the formed battery can comprise an anode of zinc, aluminum, indium, bismuth, magnesium, lithium, sodium, copper, nickel, iron, lead, cobalt or a combination thereof.

A thirty sixth aspect can include the method of any one of the nineteenth to thirty fifth aspects, wherein the formed battery can comprise a cathode of manganese dioxide, bismuth oxide, indium oxide, nickel oxide, aluminum oxide, lead oxide, zinc manganese oxide, aluminum manganese oxide, magnesium manganese oxide, lithium manganese oxide, sodium manganese oxide, cobalt oxide, lithium cobalt oxide, zinc cobalt oxide, silver oxide, zinc silver oxide, copper oxide, zinc copper oxide, vanadium oxide, zinc vanadium oxide or a combination thereof.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. An electrode-less and membrane-less battery comprising:
a cathode current collector;
an anode current collector;
a liquid or solid polymerized catholyte comprising dissolved active ions in contact with the cathode;
a liquid or solid polymerized anolyte comprising dissolved active ions in contact with the anode; and
a ceramic or solid polymerized buffer comprising active and working ions disposed between the catholyte and the anolyte.

2. The battery of claim 1, wherein the cathode current collector and the anode current collector comprise at least one of: carbon, lead, zinc, a stainless steel, copper, nickel, silver, bismuth, titanium, magnesium, aluminum, indium, tin, gold, iron, a polypropylene, or a combination thereof, and wherein the cathode current collector or the anode current collector comprises at least one of a mesh, a foil, a foam, a sponge, a felt, a fibrous cloth, a porous block architecture, or a combination thereof.

3. (canceled)

4. The battery of claim 1, wherein the liquid or solid polymerized catholyte solution comprises a mixed solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, aluminum chloride, nickel sulfate, nickel chloride, indium sulfate, lithium hexafluorophosphate, aluminum bromide, aluminum acetate, copper sulfate, copper chloride, vanadyl sulfate, vanadium chloride, lead sulfate, lead chloride, sulfuric acid, nitric acid, hydrochloric acid, sodium perchlorate, sodium hexafluorophosphate, lithium perchlorate, lithium bis(trifluoromethanesulfonyl)imide, lithium triflate, lithium bis(oxalato)borate, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrite, lithium hydroxide, lithium perchlorate, lithium oxalate, lithium fluoride, lithium carbonate, lithium bromate, silver nitrate, silver chloride, silver sulfate, a fumed silica, magnesium sulfate, magnesium chloride, aluminum sulfate, aluminum chloride, iron sulfate, iron chloride, polyvinyl alcohol, aluminum nitrate, carboxymethyl cellulose, a xanthum gum, a carrageenan, acrylamide, acrylic acid, polyacrylic acid, potassium acrylate, sodium acrylate, polyacrylamide, potassium persulfate, sodium persulfate, ammonium persulfate, potassium sulfate, sodium sulfate, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, or a combination thereof.

5. The battery of claim 1, wherein the concentration of the liquid or solid polymerized catholyte in liquid or polymerized form is of no more than about 16M.

6. The battery of claim 1, wherein the liquid or solid polymerized anolyte comprises zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, zinc triflate, aluminum sulfate, iron sulfate, aluminum chloride, iron chloride, magnesium chloride, magnesium sulfate, magnesium perchlorate, aluminum perchlorate, aluminum triflate, lithium hexafluorophosphate, aluminum bromide, aluminum acetate, ammonium chloride, sulfuric acid, nitric acid, hydrochloric acid, sodium perchlorate, sodium hexafluorophosphate, lithium perchlorate, lithium bis(trifluoromethanesulfonyl)imide, lithium bis(oxalato)borate, iron triflate, magnesium triflate, 1-methyl-1-propylpyrrolidinium chloride, 1-ethyl-3-methylimidazolium chloride, sodium hydroxide, potassium hydroxide, lithium hydroxide, zinc oxide, aluminum hydroxide, aluminum oxide, iron oxide, magnesium hydroxide, magnesium oxide, copper oxide, copper sulfate dissolved in potassium hydroxide, sodium hydroxide, or lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, bismuth sulfate, bismuth chloride, indium chloride, acrylic acid, acrylamide, polyacrylamide, polyacrylic acid, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

7. The battery of claim 1, wherein the concentration of the liquid or solid polymerized anolyte solution in liquid or polymerized form is no more than about 16 M.

8. (canceled)

9. The battery of claim 1, wherein the ceramic or solid polymerized buffer comprises a ceramic layer comprising at least one of LiSiCON, NaSiCON, combinations of Na, Li, Zn, Ge, V, Si, P, Cl and O, or a redox ion mediating layer.

10. The battery of claim 1, wherein the ceramic or solid polymerized buffer is a polymerized solution comprising at least one of: sodium acetate, acetic acid, potassium phosphate monobasic, sodium hydroxide, potassium hydrogen phthalate, potassium carbonate, potassium tetraborate, potassium hydroxide, disodium EDTA dihydrate, tris buffered saline comprising 1.37M sodium chloride, 0.027M potassium chloride, and 0.25M tris/tris-HCl, potassium phosphate monobasic, potassium chloride, hydrochloric acid, boric acid, tris-EDTA, tris hydrochloride, potassium acid phthalate, hydrochloric acid, sodium chloride-tris-EDTA, tris-acetate-EDTA, tris-borate-EDTA, phosphate buffer, borax standard buffer, tris-glycine-SDS, disodium phosphate, citric acid, monopotassium phosphate, boric acid, diethyl barbituric acid, dihydrogen potassium phosphate, sodium phosphate dibasic, potassium hydrogen phthalate, potassium biphthalate, manganese sulfate, lead sulfate, copper sulfate, vanadyl sulfate, zinc sulfate, zinc oxide, aluminum oxide, magnesium oxide, iron oxide dissolved in potassium hydroxide, sodium hydroxide or lithium hydroxide, acrylic acid, polyacrylic acid, acrylamide, polyacrylamide, potassium sulfate, sodium sulfate, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

11. The battery of claim 1, wherein the ceramic or solid polymerized buffer has a pH of less than about 13, and wherein the ceramic or solid polymerized buffer is a concentrated solution with total concentration of no more than about 16 M.

12. (canceled)

13. The battery of claim 1, wherein the ceramic or solid polymerized buffer regulates the pH in the battery.

14. The battery of claim 1, wherein a conductivity and deposition surface of the anode current collector, the cathode current collector, or both is coated with an aqueous or organic dispersion of graphite, expanded graphite, multiwalled carbon nanotubes, single walled carbon nanotubes graphene, graphene oxide or a combination thereof.

15. The battery of claim 1, wherein the battery is in a discharged state.

16.-18. (canceled)

19. A method of forming an electrode-less and membrane-less battery, the method comprising:
forming a liquid or solid polymerized catholyte comprising dissolved active ions;
forming a liquid or solid polymerized anolyte comprising dissolved active ions;
forming a ceramic or solid polymerized buffer comprising active and working ions;
layering the ceramic or solid polymerized buffer between the catholyte and the anolyte;
disposing a cathode current collector in contact with the catholyte; and
disposing an anode current collector in contact with the anolyte.

20. The method of claim 19, wherein the cathode current collector or the anode current collector comprises at least one of: carbon, lead, zinc, stainless steel, copper, nickel, silver, bismuth, titanium, magnesium, aluminum, indium, tin, gold, iron, polypropylene, or a combination thereof, and wherein the cathode current collector or the anode current collector is in the form of at least one of: a mesh, a foil, a foam, a sponge, a felt, a fibrous cloth, a porous block architecture, or a combination thereof.

21. (canceled)

22. The method of claim 19, wherein the liquid or solid polymerized catholyte comprises a mixed solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, aluminum chloride, nickel sulfate, nickel chloride, indium sulfate, lithium hexafluorophosphate, aluminum bromide, aluminum acetate, copper sulfate, copper chloride, vanadyl sulfate, vanadium chloride, lead sulfate, lead chloride, sulfuric acid, nitric acid, hydrochloric acid, sodium perchlorate, sodium hexafluorophosphate, lithium perchlorate, lithium bis(trifluoromethanesulfonyl)imide, lithium triflate, lithium bis(oxalato)borate, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium bromate, silver nitrate, silver chloride, silver sulfate, a fumed silica, magnesium sulfate, magnesium chloride, aluminum sulfate, aluminum chloride, iron sulfate, iron chloride, polyvinyl alcohol, aluminum nitrate, carboxymethyl cellulose, a xanthum gum, a carrageenan, acrylamide, acrylic acid, polyacrylic acid, potassium acrylate, sodium acrylate, polyacrylamide, potassium persulfate, sodium persulfate, ammonium persulfate, potassium sulfate, sodium sulfate, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, or a combination thereof.

23. The method of claim 19, wherein a concentration of the liquid or solid polymerized catholyte in liquid or polymerized form is less than about 16M.

24. The method of claim 19, wherein the liquid or solid polymerized anolyte comprises zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, zinc triflate, aluminum sulfate, iron sulfate, aluminum chloride, iron chloride, magnesium chloride, magnesium sulfate, magnesium perchlorate, aluminum perchlorate, aluminum triflate, aluminum chloride, lithium hexafluorophosphate, aluminum bromide, aluminum acetate, ammonium chloride, sulfuric acid, nitric acid, hydrochloric acid, sodium perchlorate, sodium hexafluorophosphate, lithium perchlorate, lithium bis(trifluoromethanesulfonyl)imide, lithium bis(oxalato)borate, iron triflate, magnesium triflate, 1-methyl-1-propylpyrrolidinium chloride, 1-ethyl-3-methylimidazolium chloride, sodium hydroxide, potassium hydroxide, lithium hydroxide, zinc oxide, aluminum hydroxide, aluminum oxide, iron oxide, magnesium hydroxide, magnesium oxide, copper oxide or copper sulfate dissolved in potassium hydroxide or sodium hydroxide or lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, bismuth sulfate, bismuth chloride, indium chloride, acrylic acid, acrylamide, polyacrylamide, polyacrylic acid, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

25. The method of claim 19, wherein a concentration of the liquid or solid polymerized anolyte in liquid or polymerized form is no more than about 16 M.

26. The method of claim 19, wherein a temperature of the liquid or solid polymerized catholyte or the liquid or solid polymerized anolyte is less than about 200° C. to form the polymer.

27. The method of claim 19, wherein the ceramic or solid polymerized buffer comprises a ceramic layer, and where the ceramic layer is LiSiCON, NaSiCON, combinations of Na, Li, Zn, Ge, V, Si, P, Cl and O, or a redox ion mediating layer.

28. The method of claim 19, wherein the ceramic or solid polymerized buffer is a polymerized solution comprising of sodium acetate, acetic acid, potassium phosphate monobasic, sodium hydroxide, potassium hydrogen phthalate, potassium carbonate, potassium tetraborate, potassium hydroxide, disodium EDTA Dihydrate, tris buffered saline comprising 1.37M sodium chloride, 0.027M potassium chloride, and 0.25M tris/tris-HCl, potassium phosphate monobasic, potassium chloride, hydrochloric acid, boric acid, tris-EDTA, tris hydrochloride, potassium acid phthalate, hydrochloric acid, sodium chloride-tris-EDTA, tris-acetate-EDTA, tris-borate-EDTA, phosphate buffer, borax standard buffer, tris-glycine-SDS, disodium phosphate, citric acid, monopotassium phosphate, boric acid, diethyl barbituric acid, dihydrogen potassium phosphate, sodium phosphate dibasic, potassium hydrogen phthalate or potassium biphthalate, manganese sulfate, lead sulfate, copper sulfate, vanadyl sulfate, zinc sulfate, zinc oxide, aluminum oxide, magnesium oxide, iron oxide dissolved in potassium hydroxide, sodium hydroxide, or lithium hydroxide, acrylic acid, polyacrylic acid, acrylamide, polyacrylamide, potassium sulfate, sodium sulfate, polyacrylic acid partially neutralized with potassium or sodium, N,N′-methylenebisacrylamide, N,N′-(1,2-dihydroxyethylene)bisacrylamide, ethylene glycol diacrylate, di(ethylene glycol) diacrylate, tetra(ethylene glycol) diacrylate, ethylene glycol dimethacrylate, di(ethylene glycol) dimethacrylate, tri(ethylene glycol) dimethacrylate, potassium persulfate, ammonium persulfate, sodium persulfate, or a combination thereof.

29. The method of claim 19, wherein the ceramic or solid polymerized buffer has a pH of less than about 13, and wherein the ceramic or solid polymerized buffer is a concentrated solution with total concentration of less than about 16 M.

30. (canceled)

31. The method of claim 19, further comprising: regulating a pH of the battery using the ceramic or solid polymerized buffer.

32. The method of claim 19, wherein a conductivity and deposition surface of the anode current collector, the cathode current collector, or both are enhanced using a coating of an aqueous or organic dispersion of graphite, an expanded graphite, multiwalled carbon nanotubes, a single walled carbon nanotubes graphene, a graphene oxide or a combination thereof.

33. The method of claim 19, wherein the battery is assembled in a discharged state.

34. The method of claim 33, further comprising:
charging the battery from the discharged state to a charged state, where the charging comprises using a constant current, a constant voltage, or a combination thereof.

35. The method of claim 34, wherein the battery in the charged state comprises an anode electroactive material comprising at least one of zinc, aluminum, indium, bismuth, magnesium, lithium, sodium, copper, nickel, iron, lead, cobalt or a combination thereof.

36. The method of claim 34, wherein the battery in the charged state comprises a cathode electroactive material comprising manganese dioxide, bismuth oxide, indium oxide, nickel oxide, aluminum oxide, lead oxide, zinc manganese oxide, aluminum manganese oxide, magnesium manganese oxide, lithium manganese oxide, sodium manganese oxide, cobalt oxide, lithium cobalt oxide, zinc cobalt oxide, silver oxide, zinc silver oxide, copper oxide, zinc copper oxide, vanadium oxide, zinc vanadium oxide, or a combination thereof.
